(19) United States
(12) Patent Application Publication
(10) Pub. No.: US 2003/0009393 A1
(43) Pub. Date: Jan. 9, 2003

(54) Systems and methods for providing purchase transaction incentives

(76) Inventor: Jeffrey Norris, Washington, DC (US)

Correspondence Address: FINNEGAN, HENDERSON, FARABOW, GARRETT &, DUNNER LLP, 1300 I STREET, NW, WASHINGTON, DC, 20006, US

(21) Appl. No.: 09/897,901

(22) Filed: Jul. 5, 2001

(51) Int. Cl. G06F 17/60

(52) U.S. Cl. 705/27

(57) ABSTRACT

A method, system, and computer are disclosed for providing purchase transaction incentives using a financial product having an identification code that may be scanned at a point-of-sale terminal. The method comprises tracking a purchase transaction by a consumer based on identification data obtained from scanning of the identification code on the financial product. Data relating to the transaction and identification data relating to the identification code are received for storage in a transaction database. A purchase transaction incentive is provided based on the stored data relating to the plurality of transactions and the stored identification data relating to the identification code. The purchase transaction incentive provides an incentive to a particular consumer to make a purchase.

### BACKGROUND OF THE INVENTION

1. Field of the Invention

The present invention relates to systems and methods for administering a retail steering strategy. More particularly, the invention relates to methods and systems for steering retail customers, the methods and systems being associated with financial products, such as credit cards or debit cards.

2. The Related Art

Systems and methods for steering customers in a retail setting are well known. Retail steering comprises applying analyses of customer data and behaviors to identify specific segments of customers who are likely to respond to various retail offers. Direct marketing channels are then used to reach these segments of customers with offers that are designed to change or “steer” the buying behavior of these segments of customers. For instance, retail steering may be used to increase frequency and/or volume of purchases, to move customers from buying relatively lower margin goods to relatively higher margin goods, or even to influence a customer to frequent one store in lieu of another.

For example, retailers often use couponing to attract customers and steer customers to visit their retail establishments. Similarly, brand managers for various products use couponing to steer customers away from other brands and toward their brand. Another known method of retail steering is the use of advertising. Retailers use advertising to entice customers to visit and transact business at their retail establishments. Similarly, brand managers use advertising to steer customers toward their brand and away from competing brands. Known couponing and advertising methods tend to be somewhat unsophisticated, since the targeting of desired customers is typically a marginally successful venture, at best. Often, resources are wasted in attempting to reach desired customers, especially when couponing or advertising reaches persons other than those desired customers.

Other methods and systems for steering retail customers are also known. For example, incentives programs have been developed to reward customers who make purchases at certain retail establishments. Perhaps the best known example of such incentives programs is the use of frequent flyer programs by airlines. By issuing airline miles for every flight taken by a customer, an airline seeks to engender loyalty in the customer. Customers in such systems are often identified by a frequent flyer number, which facilitates record keeping. However, such programs only facilitate the tracking of data relating to a customer's use of a single airline, thus limiting the ability to steer customers to specific airlines.

Broad-based loyalty programs are also known. For example, a consumer participating in a broad-based loyalty program can use an identifying token, such as a membership card or membership number, to register transactions in which they participate at more than one participating retailer. In these types of loyalty programs, member/consumers typically accrue benefits or points based on an amount of transacted business with participating retailers. Retailers buy the points from a central system administrator and award the points as they see fit. Such programs, however, do not have a retail steering strategy, as they are solely based on rewarding a customer for a purchase.

Yet another known method of steering retail customers is that of a grocery bonus club. In such clubs, customers receive a membership card with which they may receive incentives and benefits. For example, a customer may be given a coupon upon checkout for a pre-specified item which the customer purchases by presenting the customer's membership card or other token. Similarly, a customer may accrue other benefits for a volume of transactions performed with the grocery retailer. Like frequent flier programs, the downfall of these grocery bonus clubs is that they are limited to a single retailer, thus limiting the amount of data available to steer customers.

As mentioned, many different types of tokens have been used to identify customers participating in such loyalty programs. These tokens include membership cards, membership identification numbers, and the like. While such tokens have been provided, an effective retail steering strategy has not been achieved due to insufficient transaction data or the lack of a sufficient link between the token and a financial product, such as a credit card or debit card.

### SUMMARY OF THE INVENTION

Systems and methods consistent with the present invention allow an issuer of a financial product, such as a credit card, to administer a retail steering strategy linked to the financial product.

In accordance with the invention, a method, system, and computer are disclosed for providing purchase transaction incentives using a financial product having an identification code that may be scanned at a point-of-sale terminal. The method comprises tracking a purchase transaction by a consumer based on identification data obtained from scanning of the identification code on the financial product. Data relating to the transaction and identification data relating to the identification code are received for storage in a transaction database. A purchase transaction incentive is provided based on the stored data relating to the plurality of transactions and the stored identification data relating to the identification code. The purchase transaction incentive provides an incentive to a particular consumer to make a purchase.

Both the foregoing general description and the following detailed description are exemplary and are intended to provide further explanation of the invention as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

In the drawings:

FIG. 1 is a diagram of a system environment consistent with the present invention;

FIG. 2 is a diagram of an exemplary data structure for a credit card master database;

FIG. 3 is a diagram of an exemplary data structure for a transaction data repository;

FIG. 4 is a diagram of a system consistent with the present invention shown from the perspective of a participating retailer;

FIG. 5 is a flowchart of a method in accordance with the present invention;

FIG. 6 is flowchart of another method in accordance with the present invention;

FIG. 7 illustrates an exemplary method for providing incentives consistent with the present invention; and

FIG. 8 is a flowchart of an exemplary method, shown from the perspective of a customer transaction, in accordance with the present invention.

### DESCRIPTION OF THE EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

Systems and methods consistent with the present invention provide purchase transaction incentives based on a tracking of consumer transaction data. An identification code associated with or printed on a financial product is scanned at a point-of-sale terminal as part of a transaction. The identification code comprises a code that identifies the consumer associated with the financial product. This code may then be used in conjunction with various databases to retrieve information about the consumer associated with the code. Although the preferred embodiment discusses credit cards, the financial product may comprise any form of transaction card or negotiable instruments used as tender for commercial transactions, such as credit carts, debit cards, bank cards, Smart Cards, checks, and promissory notes, for example. While bar codes are discussed as part of an exemplary embodiment, any type of identification code may be used, such as numeric codes, digital codes, visual codes, magnetic codes, and the like. Point-of-sale terminals are terminals which facilitate a transaction for goods and services, such as an in-store cash register, a vending machine, a telephone, a mobile telephone, or a home computer connected to the Internet, for example. Optionally, point-of-sale terminals may include electronic verification devices, such as fingerprint readers, retinal scanners, smart wallets, radio frequency identification devices, or biometric pens, for example.

Data from each transaction are sent to a transaction data repository and analyzed to identify consumer trends to facilitate the targeting of promotional materials and special offers. For each transaction, data sent to the transaction data repository may include purchase item information, such as a listing of all items purchased, purchase prices, total dollar value of the transaction, Stock Keeping Unit (“SKU”) data, and the like. These data are associated with a credit card customer by way of the identifying code, such as a bar code, which may be scanned at the point-of-sale terminal. Data are also associated with transaction identifying information, such as store location, time and date of the transaction, and the like. Transaction data may also be related to profile information previously stored about the customer, e.g., that profile information gathered when the customer first joins the program disclosed herein.

Data for each transaction are also sent to a credit card master database for storage and analysis to identify consumer trends to facilitate the targeting of promotional materials and special offers. The data collected comprise standard transaction information for every credit card transaction, including, for example, a total amount debited to the credit card account for the transaction, a date of the transaction, and merchant information. These data are associated with a credit card customer by way of a credit card account number, which may be encoded in a magnetic strip for reading at a point-of-sale terminal.

Based on analysis of data from the transaction data repository and the credit card master database, targeted offers may be developed to provide incentives to certain groups of customers. These targeted offers may be instantaneous, as in the case of an instant coupon, or ongoing, as in the case of a loyalty rewards program or a credit enhanced shopping program. The system and method may be instituted with a plurality of merchants, so as to increase the amount of transaction data to be analyzed and to provide the consumer with numerous and varied promotions and special offers.

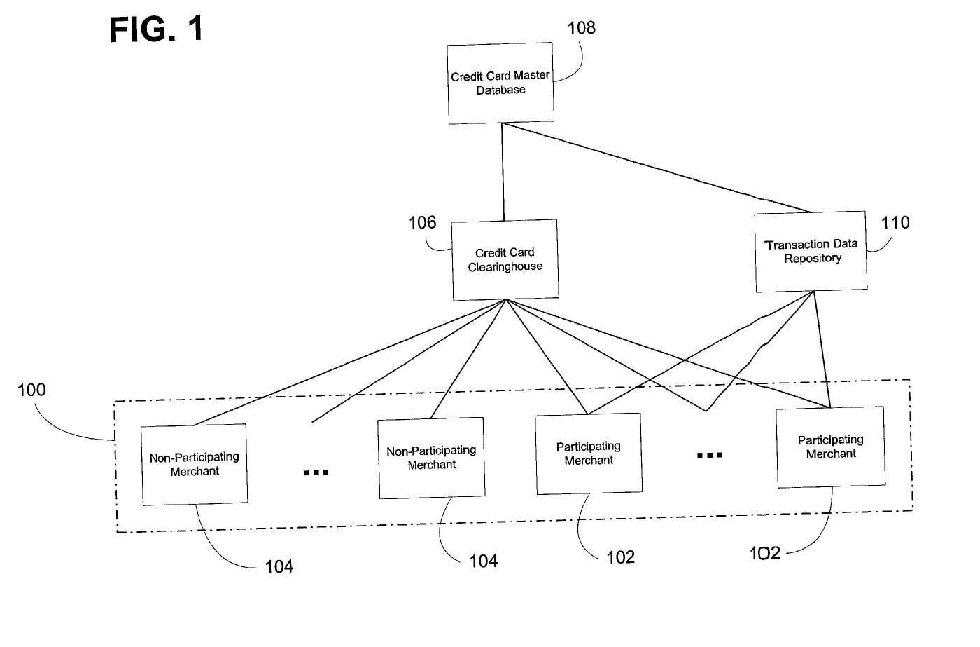

Referring now to FIG. 1, an exemplary system environment for implementing the features of the present invention will be described. The set of all merchants 100, represented in the dashed box, comprises a plurality of participating merchants 102 and a plurality of non-participating merchants 104. Participating merchants 102 comprise those merchants who have partnered with the issuer of a financial product, such as a credit card issuing entity, for purposes of practicing the present invention. Non-participating merchants 104 are merchants who have not partnered with a credit card issuing entity, but who are nonetheless members of a credit card network.

Non-participating merchants 104 are operatively connected to a credit card clearinghouse 106. In this way, when a customer transacts business with a nonparticipating merchant and uses a credit card to tender payment, data related to the transaction may be transmitted to credit card clearinghouse 106. Similarly, participating merchants 102 are also connected to the credit card clearinghouse 106 so that data are passed to the clearinghouse 106 for each transaction. The transaction data are then passed to a corresponding credit card issuing entity, wherein the data are stored in a credit card master database 108. While FIG. 1 shows only one credit card master database 108, one skilled in the art will recognize that there may be many such databases 108 operatively connected to the clearinghouse 106, typically one for each different credit card issuing entity.

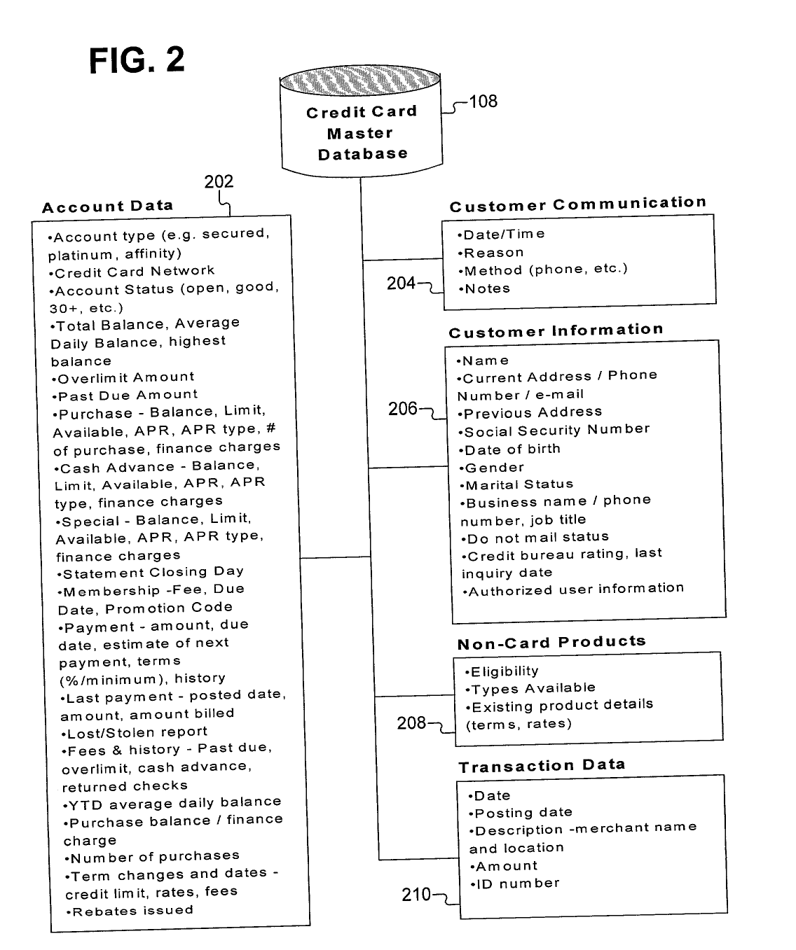

An exemplary data structure for credit card master database 108 is presented in FIG. 2. Credit card master database 108 may comprise any number of data segments, such as an account data segment 202, a customer communication segment 204, a customer information segment 206, a non-card products segment 208, and a transaction data segment 210. Account data segment 202 may store information relating to a credit card customer's account data. This information may include, by way of example, account type, credit card network, account status, total balance, average daily balance, high balance, over-limit amount, past due amount, purchase information, cash advance information, card membership information, payment information, fee history, and the like. As used in FIG. 2, “APR” stands for annual percentage rate. Customer communication segment 204 may include summary data relating to communications between the credit card issuer and the customer. Customer information segment 206 may store background information about the customer. This information may include, by way of example, the customer's name, address, telephone number, e-mail address, previous address, social security number, date of birth, gender, marital status, business name, business telephone number, job title, “do not mail” status, credit bureau rating and last inquiry date, and other authorized user information. Non-card products segment 208 may include information about a cardholder's participation and eligibility for other products of the card issuer. Finally, transaction data segment 210 may contain listings of credit card transactions by the customer, including by way of example, date of transaction, posting date, merchant name, merchant location, amount of transaction, and an identification number.

Turning again to FIG. 1, a credit card master database 108 at a credit card issuing entity may be operatively connected to a transaction data repository 110. The transaction data repository 110 may also be operatively connected to the plurality of participating merchants 102. Transaction data repository 110 stores detailed information about each transaction, such as stock keeping unit (SKU) and Standard Industrial Code (SIC) data, as well as data relating to the transaction, such as date, time, items purchased, purchase price, payment method, total transaction value, and the like. Connections among and between elements in the exemplary system environment of FIG. 1 may be accomplished using any known wireless, wireline, or network connection scheme.

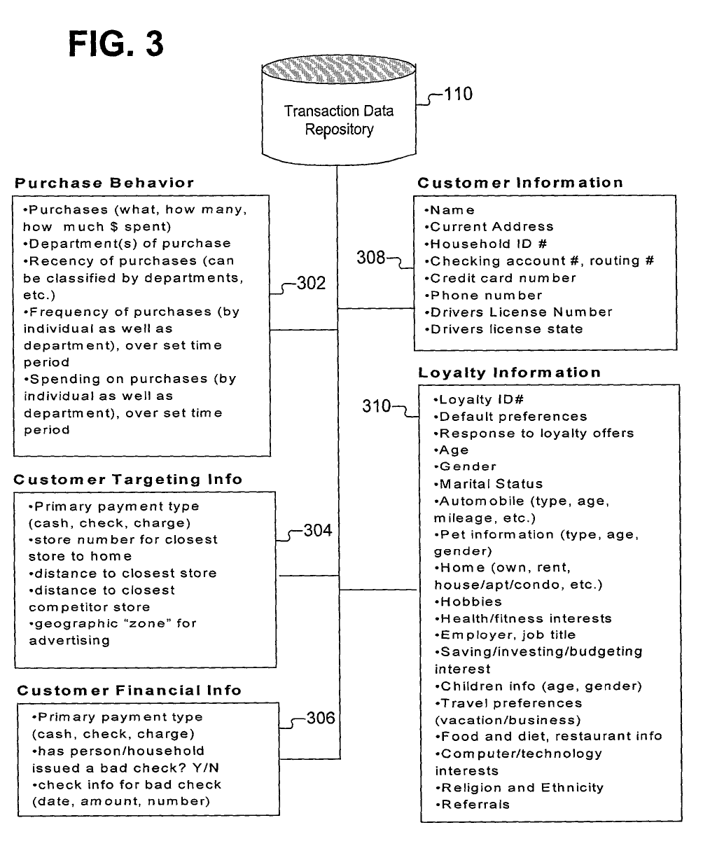

An exemplary data structure for transaction data repository 110 is presented in FIG. 3. Transaction data repository 110 may comprise any number of data segments, such as a purchase behavior segment 302, a customer targeting information segment 304, a customer financial information segment 306, a customer information segment 308, and a loyalty information segment 310. For each credit card transaction, purchase behavior segment 302 may memorialize information including, by way of example, items purchased, quantity, SKU numbers, purchase price, department of purchase, and date of purchases. Customer targeting information segment 304 may include a customer's primary payment type (e.g., cash, check, or charge), a store identifier for a participating retailer closest to the customer, a distance to that closest retailer, a distance to the closest stores of predetermined competitors, and a geographic “zone” for advertising purchases. Customer financial information segment 306 may include, for each customer, a primary payment type, bad check indicator (i.e., a flag if the customer has passed a bad check), and information relating to bad checks. Customer information segment 308 may include, by way of example, the customer's name, current address, household identification number, checking account number and routing number, credit card number, telephone number, and driver's license number and jurisdiction. A household identification number is a unique identifier for a single household which is used to associate multiple cardholders living in that same household.

Transaction data repository 110 may also comprise a loyalty information segment 310 for administering a loyalty rewards program. For each customer, loyalty information segment 310 may include, by way of example, a loyalty program identification number, history of responses to loyalty offers, age, gender, marital status, automobile information, pet ownership information, home ownership/rental information, hobbies, health and fitness interests, employer, job title, saving and investing interests, information about children, travel preferences, food preferences, computer and technology interests, religion information, ethnicity information, and referral information. Data residing in transaction data repository 110 may be based on information received from customers, such as when a customer submits an application or survey to the financial account issuer. Moreover, data for transaction data repository 110 may be garnered from public sources. Such data may be updated at the discretion of an owner of the transaction data repository 110.

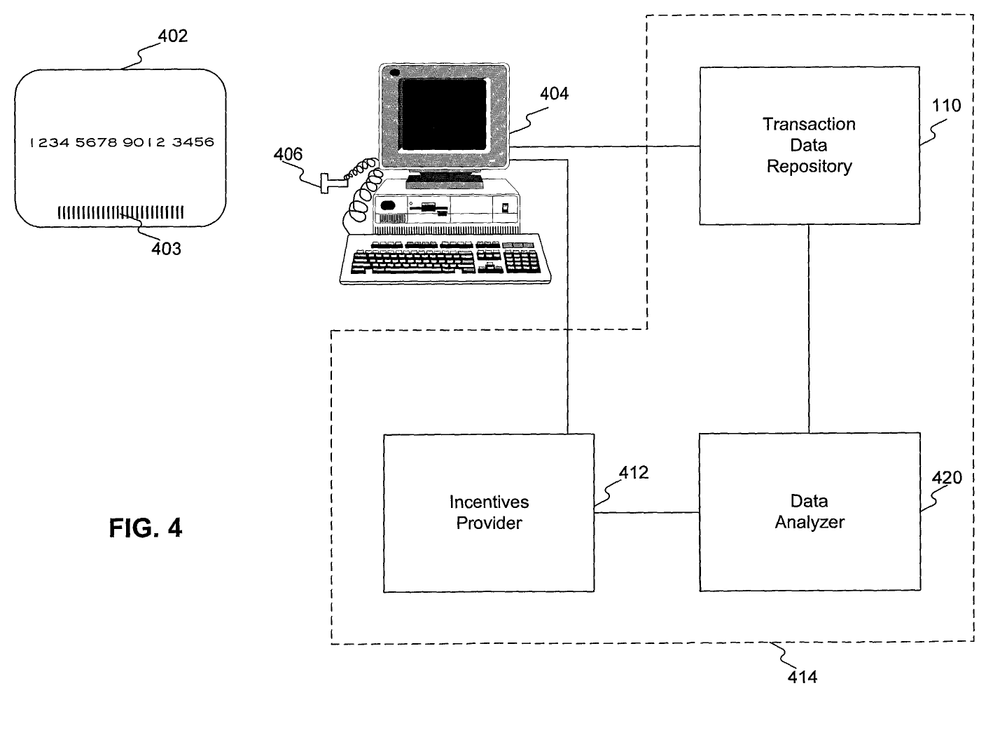

Turning to FIG. 4, an illustration of an exemplary system in accordance with the present invention is presented from the perspective of a participating merchant. A customer (not shown) may tender a credit card 402 having a bar code 403, or other indicia, printed thereon. Credit card 402 has the same functionality as any credit card known in the art. For example, credit card 402 may comprise a piece of plastic having a unique identifying number thereon, as well as a magnetic strip which includes an electronic representation of information relating to credit card 402. Optionally, credit card 402 may comprise a Smart Card having a Smart Card memory chip or may be implemented as a debit or bank card. Bar code 403 comprises a printed bar code having a separate and distinct identifying number or alphanumeric sequence from that of the credit card 402. Bar code 403 encodes identifying information that identifies the customer who is the holder of card 402. Further, as opposed to a bar code, code 403 may alternatively comprise any sort of indicia printed on the financial product, or it may comprise any sort of electronically encoded indicia present with the financial product. Examples of electronically encoded indicia include those encoded in existing or additional magnetic strips, those encoded in a Smart Card memory, and those encoded in magnetic ink. Credit card 402 may be issued to existing credit card customers as part of a normal course of credit card replacement, or, alternatively, may be issued to credit card customers as part of a new card marketing campaign.

At a point-of-sale terminal 404, credit card 402 may be used to tender payment for a set of purchases. Moreover, point-of-sale terminal 404 may comprise a bar code scanning device 406. Bar code scanning device 406 may be used to scan bar codes on individual pieces of merchandise as a means of ringing up purchases at point-of-sale terminal 404. Bar code scanning device 406 may also be used to scan bar code 403, as printed on credit card 402. Optionally, a customer may tender payment coming from a source other than credit card 402 and still use credit card 402 and, more specifically, bar code 403, to track transactions made by the customer. For example, a customer may tender a cash payment for a set of purchases, but still use credit card 402 to register the transaction. In this way, any known method of payment may be used to pay for the subject transaction and data for steering purposes will still be collected.

Once transaction data are entered using bar code scanner 406, these data are then sent to transaction data repository 110. Transaction data repository 110 is operatively connected to point-of-sale terminal 404, either directly or indirectly via a credit card clearinghouse network. One skilled in the art will recognize that a credit card transaction at a participating merchant 102 using credit card 402 will result in the storing of data in both the transaction data repository 110 and the credit card master database 108. A transaction at a participating merchant 102 where something other than a credit card is tendered will cause data to be stored only at the transaction data repository 110 only if the customer presents the credit card 402 for scanning of code 403 for recordation purposes. Conversely, a transaction at a non-participating merchant 104 may also result in the storing of data at the credit card master database 108. This may occur only when a customer of the non-participating 104 merchant uses a credit card. In this case, transaction data obtained from the use of the credit card 402 are stored in credit card master database 108.

Also operatively connected to transaction data repository 110 is data analyzer 420. Data analyzer 420 analyzes data from transaction data repository 110 in order to identify customer trends which may be useful to subscribing merchants. Data analyzer 420 is operatively connected to incentives provider 412. Results from data analysis coming from data analyzer 420 are fed to incentives provider 412. Incentives provider 412 takes the results of the data analysis to target promotional materials and offers to customers based on their buying habits. For example, incentives provider 412 may provide coupons to a customer based on transaction data from customers. Coupons may be instant, mailed, “virtual,” or any other form of coupon known in the art. Similarly, incentives provider 412 may apply percentage discounts instantly, retrospectively, or prospectively to any given transaction.

Moreover, incentives provider 412 may administer loyalty programs stemming from purchases made at a plurality of point-of-sale terminals 404. For example, customers may be given loyalty rewards points for making purchases at participating retailers. Incentives provider 412 would track the accumulation of such points and the dissemination of awards based on those points. These loyalty rewards points may be amassed by customers at any of one or more participating retailers. In this way, a plurality of retailers may use the same machinery to participate in a single loyalty rewards program. Loyalty rewards also have the virtue of providing additional incentives for customers so as to overcome customers' concerns about the accumulation of data regarding customer habits.

Incentives provider 412 may optionally administer methods and systems for “credit enhanced shopping.” Credit enhanced shopping is defined as providing a line-of-credit which is exclusive to one or more retailers to enhance a customer's potential buying power. This line-of-credit may be applied in a single private-label credit card, or it may be an additional function to a traditional credit card. For example, a small number of merchants may be tied by a common private-label credit card, so that payments may be tendered to those merchants with the private-label credit card. In this respect, credit enhanced shopping may apply to the same or similar merchants as those involved in a loyalty rewards program. Credit enhanced shopping may comprise a dual line-of-credit on a single card: One credit limit may be exclusive to a single retailer, while the other may be a general line-of-credit. A credit card with multiple lines of credit may be implemented, for example, in accordance with U.S. patent application Ser. No. 09/659,585 entitled “System And Method For Providing A Credit Card With Multiple Credit Lines,” which is commonly owned and expressly incorporated by reference herein.

Incentives provider 412 may also be operatively connected back to the plurality of point-of-sale terminals 404 in order to facilitate instant targeting of promotional materials and offers to customers. This connection may be made by way of any known file transfer protocol (e.g., TCP/IP) which is mutually agreeable between a participating merchant 102 and an owner of the transaction data repository 1 10. Optionally, transaction data repository 110, data analyzer 420, and incentives provider 412 may be included in a single computer, here symbolically illustrated by dashed lines 414.

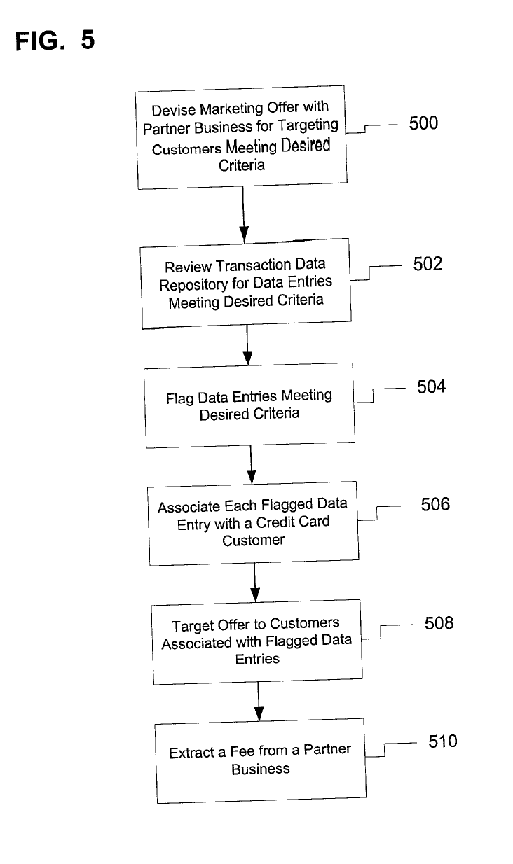

Turning now to FIG. 5, an exemplary flowchart of a method consistent with the present invention is provided. The flowchart of FIG. 5 illustrates an example of a retail steering method where it is desired to change a customer's behavior with a partner business based on data in the transaction data repository 110. For purposes of this disclosure, a partner business could comprise a retail business, a service provider, or a producer of retail goods, for example. At step 500, a marketing offer is devised with a partner business for targeting customers meeting desired criteria. For example, a partner business, such as a lawn fertilizer business, may wish to boost sales for its fertilizer. To do so, it may wish to target likely fertilizer buyers with a coupon campaign. Thus, for example, it may be desirable to target those customers who have purchased a lawnmower in the past 6 months. The lawn fertilizer business would benefit by having a uniquely targeted group of consumers who, for example, fit a do-it-yourself, yard-owning profile.

In step 502, the transaction data repository 110 is reviewed for data entries meeting the desired criteria identified in step 500. These desired criteria may include data relating to specific purchases which have been registered at participating merchants 102. The desired criteria could be chosen to cull the transaction data repository for entries meeting this profile. As mentioned previously, data entries may be culled from the transaction data repository 110 based on data as precise as SKU data, thus aiding this targeted cull of repository data.

In step 504, data entries meeting the desired criteria in the transaction data repository 110 are flagged. These flagged entries are associated with customers in step 506. This may be accomplished via known database administration techniques by linking data entries within the credit card master database 108 or by linking data entries in credit card master database 108 with those of the transaction data repository 110. Links made between credit card master database 108 and transaction data repository 110 may be associated by any common data field in the two databases. By associating customers with the flagged entries, the credit card issuing agency is able to determine which customers will be the subject of their incentives offer. In the previous example, step 506 will yield a list of customers who have purchased a lawnmower in the last 6 months.

In step 508, an offer is targeted to the customers associated with flagged data entries. Continuing with the previous example, the credit card issuing agency could administer a coupon campaign on behalf of the lawn fertilizer business. Thus, a coupon could, for example, be mailed with monthly credit card statements, the coupon offering a percentage discount on lawn fertilizer purchases. In step 510, a fee may be extracted from the partner business comprising, for example, a flat fee, a percentage of resulting sales, or any combination thereof.

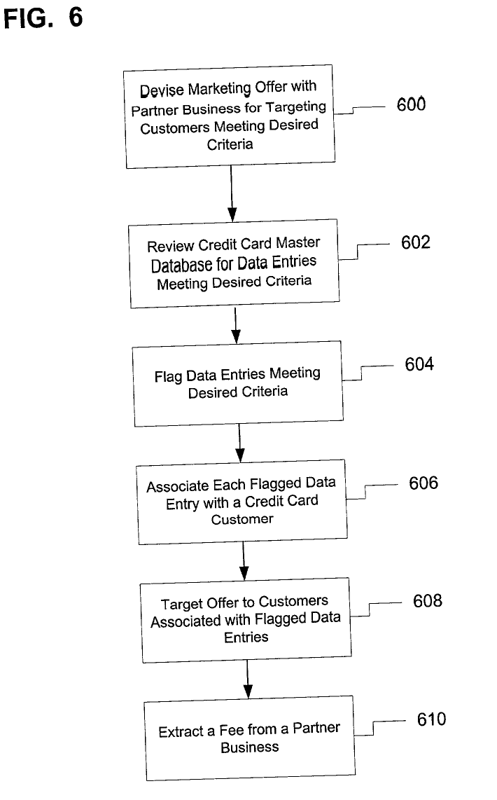

Turning now to FIG. 6, a flowchart of an exemplary method consistent with the teachings of the present invention is provided. The flowchart of FIG. 6 illustrates an example of a retail steering method for a situation where it is desired to change a customer's behavior with a partner business based on data in the credit card master database 108. One skilled in the art will recognize that a credit card issuing agency can search its existing credit card master database 108, which comprises data from participating and non-participating merchants alike, for entries meeting desired criteria.

At step 600, a marketing offer is devised with a partner business for targeting customers meeting desired criteria. For example, a partner business, such as a home improvement retailer, may wish to obtain more and different customers. To do so, it may wish to target customers who have a history of frequenting a competitor home improvement retailer. The partner home improvement retailer would benefit by having a uniquely targeted group of consumers who typically shop at competitors' home improvement stores. In an exemplary embodiment, the partner business is also a participating merchant 102.

In step 602, the credit card master database 108 is reviewed for data entries meeting the desired target criteria, such as those customers who spent at least $200 at a competitor home improvement store over the last two months. These desired criteria may include data relating to purchases made as certain merchants, such as competitor home improvement stores, for example. In contrast to the method of FIG. 5, data entries may be culled from the credit card master database 108 based on merchant and total transaction amount, for example.

In step 604, data entries meeting the desired criteria in the credit card master database 108 are flagged. These flagged entries are associated with customers in step 606. Continuing the previous example, this is accomplished by associating a customer who made a purchase at a competitive home improvement store with data relating to the purchase amount, time, etc. By associating customers with the flagged entries, the credit card issuing agency is able to determine which customers will be the subject of their incentives offer. In the previous example, step 606 will yield a list of customers who have purchased at least $200 at a competitor home improvement store over the last two months.

In step 608, an offer is targeted to the customers associated with flagged data entries. Continuing the previous example, the credit card issuing agency could administer a rebate campaign on behalf of the partner home improvement retailer. Thus, for example, a customer could obtain a $10 rebate for each $100 the customer spent at the partner home improvement retailer. The customer could be notified about the availability of the offer by an insert in a credit card bill, a phone call, or an e-mail, for example. The rebate could then require a customer to send in a form and/or it may be applied automatically to the customer's bill. In step 610, a fee may be extracted from the partner business comprising, for example, a flat fee, a percentage of resulting sales, or any combination thereof.

One skilled in the art will recognize that the methods depicted in FIGS. 5 and 6 may be practiced separately or in combination with one another. For example, an offer may be targeted based on data located or combined from both the transaction data repository 110 and the credit card master database 108.

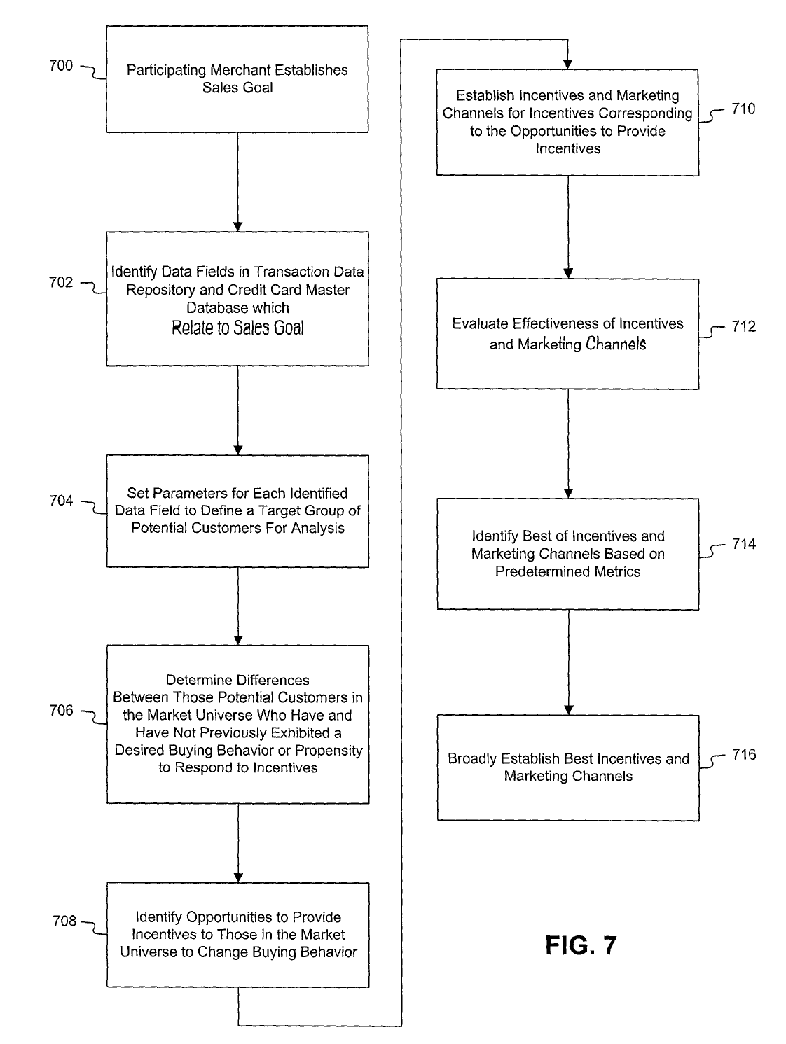

Turning now to FIG. 7, an exemplary method is illustrated for providing incentives consistent with the present invention. The method of FIG. 7 demonstrates a process for developing incentives consistent with the present invention. In step 700, a participating merchant establishes a sales goal. The participating merchant may, for example, establish the sales goal based on a desire to increase sales for a slower-selling item or service or to change a customer's behavior in a predetermined way. In step 702, the credit card issuer (with or without the assistance of the participating merchant), via data analyzer 420, identifies data fields in the transaction data repository 110 and/or the credit card master database 108 which relate to the sales goal. Selection of the data fields is typically based on some hypothesis of what kinds of customers may respond to an offer aimed at meeting the sales goal.

The credit card issuer (with or without the assistance of the participating merchant), via data analyzer 420, sets parameters for each identified data field to define a target group of potential customers for analysis (step 704). Again, the parameters may be set based on some hypothesis of what kinds of customers may respond to an offer aimed at meeting the sales goal. In particular, data analyzer 420 may then use these parameters to cull a group of data entries meeting those parameters. The culled group of data entries correspond to a culled group of potential customers, referred to as the “market universe.” Thus, the potential customers in the market universe meet all of the parameters set in step 704.

In step 706, data analyzer 420 determines attributes of those potential customers in the market universe who have previously exhibited a desired buying behavior or propensity to respond to incentives. Data analyzer 420 also determines those potential customers who have not exhibited the desired buying behavior or propensity to respond to incentives. Analyzer 420 then compares the data stored in transaction data repository 110 for those customers who respond to incentives with those that do not. From this comparison, analyzer 420 identifies the data entries that are distinguishable between the two groups of potential customers. These data entries may describe the attributes of those customers who respond to incentives. Based on the attributes, data analyzer 420 identifies opportunities to provide incentives to those who have not previously exhibited the desired buying behavior or propensity to respond to incentives (step 708). These incentives will be targeted to change potential customers' behavior toward the sales goal in accordance with the desired buying behavior or propensity to respond to incentives.

In step 710, incentives provider 412 establishes one or more incentives and one or more marketing channels corresponding to the opportunities to provide incentives identified in step 708. The term “marketing channels” relates to methods for reaching, communicating, and/or interacting with potential customers, such as in-store couponing, television and media advertising, telemarketing, and the like.

Data analyzer 420 or incentives provider 412 may store a matrix in memory (not shown) that associates possible incentives with the proposed channels. For instance, the matrix may associate each incentive with one or more types of marketing channels. Incentive provider 412 may then access this matrix to determine the appropriate marketing channel to use for providing the incentive to the customers. For instance, each of the possible combinations from the matrix may then be used in a targeted test offer for a relatively small group of customers. Such offers may last a predetermined length of time, for example one month, so resulting changes in purchase behavior may be determined over this period.

In step 712, data analyzer 420 evaluates the effectiveness of incentives and marketing channels based on the results of the targeted test offers. This step may comprise comparing the changes in sales for targeted items from each combination in the matrix of incentives and marketing channels. In step 714, data analyzer 420 identifies the best of the incentives and the marketing channels. Some, none, or all of the combinations of incentives and marketing channels may be deemed successful and worthy of implementing more broadly based on, for example, predetermined metrics and/or ordered results from the targeted test offers. Similarly, variations on each of the combinations may be broadly implemented without departing from the scope of the present method.

An example will now be described that illustrates the incentive management process described above with respect to FIG. 7. In this example, a participating retailer X determines that it would like to sell more of a certain types of lawnmowers. Retailer X's lawnmower sales are slightly below forecast and behind that of X's competitors, leading to a potential for high inventory at the end of a marketing period. The certain lawnmower sells for $150 at retailer X and at all of X's major competitors, while the price is slightly higher at niche shops.

As part of step 702, the credit card issuer (with or without the assistance of retailer X), via data analyzer 420, identifies data fields in the transaction data repository 110 and the credit card master database 108 which relate to the goal of selling more of the certain lawnmowers. In this example, identified data fields from the transaction data repository 110 may include, for example, purchase data, geographic zone, home ownership, lawn care enthusiasts (e.g., from “hobbies” in loyalty information 310), landscaping business owners (e.g., from “employer” in loyalty information 310), gender, and primary payment type. Identified data fields from the credit card master database 108 may include, for example, transaction description and amount, “do not mail” status, gender, risk of defaulting, and available credit limit.

As part of step 704, the credit card issuer (with or without the assistance of the participating merchant), via data analyzer 420, may set parameters for the identified data fields to define the types of customers to target the incentive. In this example, the identified customers are those who bought a lawnmower in the last 18 months. The set parameters may also allow identification of what else these same customers bought over their next several transactions. Moreover, the market universe may include a geographic zone component. For instance, a geographic zone may be selected to include customers in non-urban areas, because it is illogical to target people in urban areas with a lawnmower offer. Similarly, homeowners would be culled because they are preferred to renters in this example. Customers who have shopped at retailer X's competition over the last 18 months and made purchases at or above $150 may also be selected. Finally, those with a “do not mail” status may be rejected to avoid sending offers to those who wish not receive incentives and marketing offers.

As mentioned above, data analyzer 420 determines attributes of, on one hand, those potential shoppers in the market universe who have previously exhibited a desired buying behavior or propensity to respond to incentives, and, on the other hand, those who have not exhibited the desired buying behavior or propensity to respond to incentives (step 706). In the example above, such attributes may include, for example:

People who bought lawnmowers at retailer X often returned shortly thereafter to purchase a gas can.

The lawnmower buyers were predominantly male, ages 22-45, who owned their own home, and lived in the suburbs.

Landscape business owners did not buy lawnmowers at retailer X.

There was a spike in purchases over $150 at the competitors' stores that correlated with an advertising campaign and offer of “10% off of a lawn trimmer with purchase of lawnmower.”

75% of lawnmower purchases were made with a credit card at retailer X.

Nearly all lawnmower buyers use the Internet and have an e-mail address, and many have online account servicing for their credit card.

From these data, a market universe of customers is estimated, excluding people who have made the purchase of lawnmowers at retailer X in the last 18 months, which need not be targeted in this example based on estimates from historical data.

For example, it may be determined that, among people in the market universe who had spent at least $150 in the last 6 months, nearly all of these people had also shopped at retailer X in the last 6 months. The analysis may further uncover, for example:

Nearly 50% of those spending greater than $150 at other retailers bought a gas can from retailer X within days of their purchase at the competition, though it is not known if the $150 or greater purchase was for a lawnmower.

Additionally, there is a trend toward a reduction in spend flow from retailer X to the competition for these customers. “Spend flow” relates to a percentage of total spending that is made in a predefined category of merchants or products by a cardholder. Thus, it seems that these customers are becoming less loyal.

However, there is still a decent population whose spend flow has remained stable.

Based on these analyses, data analyzer 420 identifies opportunities to provide incentives to those who have not exhibited the desired buying behavior or propensity to respond to incentives, as shown in step 708. It may be determined that a customer in the market universe who is loyal to retailer X buys fertilizer at one rate, while those who are not as loyal have purchased far less fertilizer. Similarly, those who are not as loyal are purchasing markedly less hand tools (rakes, hoes, etc.) than the loyal group. Also, among the non-loyal group, those who buy a lawnmower almost always buy a gas can.

In continuing the previous example, incentive provider 412 may then establish the following incentives (as shown in step 710):

Straight coupon for discount on lawnmower.

Buy lawnmower, get free gas can.

Buy lawnmower, get 10% off of other purchases.

Buy lawnmower, get free lifetime blade sharpening.

Trade in your old lawnmower, get discounts on hand tools.

Join a “yardman's club,” e.g., buy a lawnmower and get discounts on year-round yard products as well as a monthly e-letter with advice and hints.

Based on the proposed incentives, incentives provider 412 may then establish the following channels (as shown in step 710):

Insert incentive offer into credit card statement.

Include incentive offer in coupon accompanying credit card statement.

Use direct mail offer.

Use e-mail offer.

Use Internet offer.

Use inbound telemarketing offer.

In this example, the market universe may be males between the ages of 22 to 45, who own a home, live in the suburbs, were not landscape business owners, and who had not purchased a lawnmower in the last 18 months. In step 710, incentives provider 412 may provide targeted test offers to this market universe, each being small in scope and each relating to a unique combination of an incentive and a marketing channel. For data analysis purposes, incentives may also be provided to a control group and test groups, and a correlation may be performed between the test group and the control group.

Consider that, in the previous example, not all test combinations provided sales increases at retailer X, but some combinations were particularly effective.

Therefore, each of the possible combinations are evaluated by data analyzer 420 in step 712. The best of these combinations may then be identified by data analyzer 420 (as shown in step 714). For example, the most effective marketing channel may have been the statement coupon, and the best incentives may have been establishing a yardman's club and providing free gas can for those in the market universe. A campaign of incentives may be broadly implemented to establish the yardman's club with the offer for a free gas can. Results of this offer may then be updated periodically (e.g., monthly), and after a predetermined time, for example 6 months, further observations may be made. For example, there may have been a substantial increase in sales of lawnmowers as a result of this offer (e.g., a 4% increase compared to sales before the campaign).

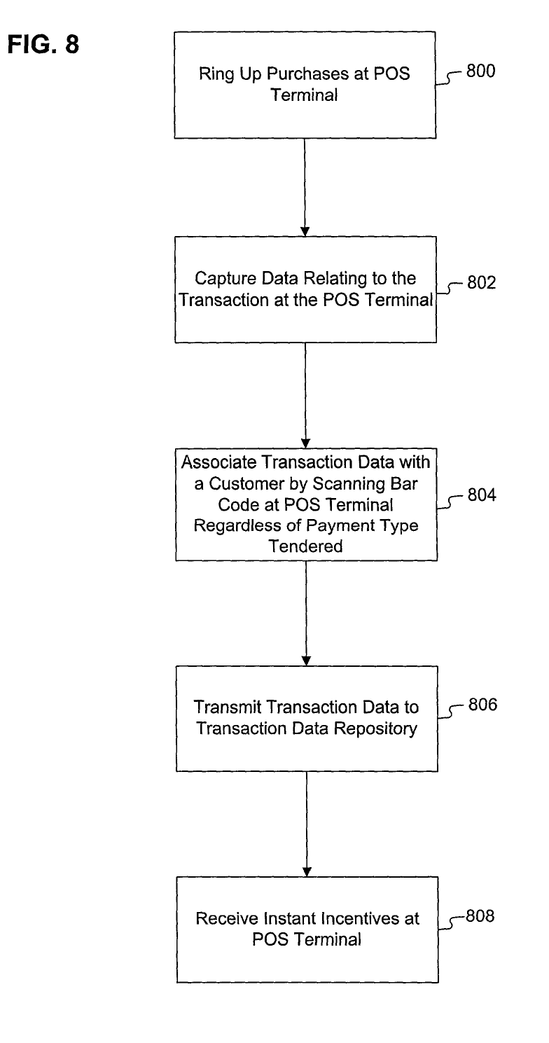

FIG. 8 is a flow diagram of an exemplary method consistent with the present invention which is illustrated from the perspective of a customer transaction at a participating merchant 102. In step 800, purchases are entered or rung up at a point-of-sale (POS) terminal 404 in a normal manner. In step 802, data relating to the transaction are captured at the POS terminal 404. These data may essentially correspond to the transaction data typically obtained during a credit card transaction. For instance, these data may include, for example, a listing of all items purchased, purchase prices, date, time, payment method, total dollar value of the transaction, SKU data, and the like. As described above, credit card master database 108 and/or transaction data repository 110 stores these data. The customer's credit card 402 is then presented to the cashier. In step 804, transaction data are associated with a customer by scanning bar code 403 on credit card 402 at the POS terminal 404. Association step 804 may be performed regardless of the type of payment tendered by the consumer. For example, a consumer may tender cash, but present credit card 402 bearing the bar code 403 to a merchant at the same time. The merchant can accept the cash tender and scan the bar code 403, so that the consumer data are captured in regard to the transaction. This same method may be used for check tenders as well. Typically, however, a consumer will use credit card 402 bearing the bar code 403 to tender payment, so that the same credit card may be used to track the transaction data arising from the transaction. Thus, a customer has incentive to present the credit card 402, thus benefiting the credit card issuing entity with increased frequency of use.

Once data are captured at POS terminal 404, these data relating to the transaction are transmitted to a transaction data repository 110, as illustrated in step 806. Any other data relating to the transaction may similarly be sent to the transaction data repository 110. Optionally, in step 808, instant incentives may be received in response to transmission step 806. Such incentives may comprise, for example, an instant coupon or percentage discount. In one aspect of the present invention, the mode in which incentives are redeemed is customized based on the preferences of the customer.

Other embodiments of the invention will be apparent to those skilled in the art from consideration of the specification and practice of the invention disclosed herein. For example, the present invention has been described with reference to purchases of merchandise. However, one skilled in the art will recognize that the instant invention is equally applicable to any sort of goods and services being bought, sold, or traded. Moreover, while the invention is disclosed with reference to examples of credit card based systems and methods, the invention may be implemented with systems and methods using other types of financial products, such as Smart Cards, debit cards, bank cards, checks, promissory notes, and the like. It is intended that the specification and examples be considered as exemplary only, with a true scope and spirit of the invention being indicated by the following claims.

What is claimed is:

1. A method for providing purchase transaction incentives using a financial product having an identification code that may be scanned at a point-of-sale terminal, the method comprising:
tracking a purchase transaction by a consumer based on identification data obtained from scanning of the identification code on the financial product;
receiving data relating to the transaction and receiving identification data relating to the identification code for storage in a transaction database; and
providing a purchase transaction incentive based on the stored data relating to the transaction and the stored identification data relating to the identification code, wherein the purchase transaction incentive provides an incentive to the consumer to make a purchase.

2. The method of claim 1, wherein the transaction data received from tracking the purchase transaction identify at least one of the items purchased, a merchant associated with the purchase, and the time the consumer made the purchase.

3. The method of claim 1, wherein the identification code identifies a particular consumer.

4. The method of claim 1, wherein receiving the transaction data and the identification data further includes:
associating the transaction data for a particular transaction with the identification data for that transaction; and
storing the transaction data and the identification data in the transaction database based on the association between the transaction data and the identification data.

5. The method of claim 1, wherein providing the purchase transaction incentive further includes:
selecting a subset of the stored transaction data based on predetermined market criteria describing a market population of consumers;
associating the selected subset of the stored transaction data with at least one particular consumer based on the stored identification data; and
providing the purchase transaction incentive to the at least one particular consumer.

6. The method of claim 5, wherein the predetermined market criteria correspond to selected transaction data stored in the transaction database.

7. The method of claim 5, wherein providing the purchase transaction incentive further includes:
identifying whether the consumers associated with the selected subset of the stored transaction data have purchased an item;
determining attributes of a first group of consumers in the market population who have purchased the item;
determining attributes of a second group of consumers in the market population who have not purchased the item; and
determining differences between the first group of consumers and the second group of consumers to identify attributes of consumers exhibiting a desired buying behavior.

8. The method of claim 7, wherein the attributes of the first and second group of consumers are included in the stored transaction data.

9. The method of claim 7, wherein providing a purchase transaction incentive further includes:
providing incentives to consumers in the second group of consumers.

10. The method of claim 5, wherein providing the purchase transaction incentive further includes:
selecting a marketing channel for providing the purchase transaction incentive to the market population of consumers; and
evaluating the success of the purchase transaction incentive, as provided through the marketing channel, based on the stored transaction data.

11. The method of claim 10, wherein evaluating the success of the purchase transaction incentive further includes:
associating stored transaction data with consumers who were provided the purchase transaction incentive based on the identification data;
analyzing the associated transaction data to determine whether the consumer purchased the item associated with the purchase transaction incentive; and
evaluating the success of the purchase transaction incentive based on the determined purchases of the item.

12. The method of claim 10, wherein providing the purchase transaction incentive further includes:
selecting a plurality of marketing channels for providing the purchase transaction incentive to the market population of consumers; and
ranking each marketing channel based on the success of the purchase transaction incentive as provided through that marketing channel.

13. The method of claim 12, wherein providing the purchase transaction incentive further includes:
providing the purchase transaction incentive using the highest ranked marketing channel.

14. The method of claim 5, wherein providing the purchase transaction incentive further includes:
providing a plurality of purchase transaction incentives to the market population of consumers; and
ranking each purchase transaction incentive based on the success of the purchase transaction incentive.

15. The method of claim 14, wherein ranking the purchase transaction incentive further includes:
associating stored transaction data with consumers who were provided the purchase transaction incentive based on the identification data;
analyzing the associated transaction data to determine whether the consumer purchased the item associated with the purchase transaction incentive; and
ranking the purchase transaction incentive based on the determined purchases of the item.

16. The method of claim 14, wherein providing the purchase transaction incentive further includes:
providing to the consumer the highest ranked purchase transaction incentive.

17. The method of claim 1, wherein the transaction is at least one of a credit card transaction, a cash tender transaction, and a check tender transaction.

18. The method of claim 17, wherein the transaction is a credit card transaction using a credit card other than the credit card with the identification code.

19. The method of claim 1, wherein the purchase transaction incentive comprises a discount for an offered item.

20. The method of claim 1, wherein providing the purchase transaction incentive further includes:
associating the stored transaction data with at least one particular consumer based on the stored identification data; and
providing the incentive to the at least one particular consumer based on the transaction data associated with the particular consumer.

21. The method of claim 20, wherein providing a purchase transaction incentive further includes:
issuing to the at least one particular consumer reward points that may be used in a rewards point redemption program.

22. The method of claim 20, wherein providing a purchase transaction incentive further includes:
providing to the at least one particular consumer credit enhanced shopping opportunities.

23. The method of claim 20, wherein providing a purchase transaction incentive further includes:
providing to the consumer an advertisement to purchase an item.

24. The method of claim 20, further including:
using the identification code to facilitate a return of a purchased item to a merchant.

25. The method of clam 1, wherein the identification code identifies the consumer as belonging to a predefined group of consumers that may receive discounts when transacting with a participating retailer.

26. The method of claim 1, wherein tracking a purchase transaction by a consumer further includes:
determining whether the consumer is eligible for an instant purchase transaction incentive.

27. The method of claim 26, wherein providing a purchase transaction incentive further includes:
providing an instant purchase transaction incentive at the point-of-sale terminal.

28. The method of claim 27, wherein the instant purchase transaction incentive comprises an instant coupon.

29. The method of claim 27, wherein the instant purchase transaction incentive comprises a percentage discount.

30. The method of claim 27, wherein the instant purchase transaction incentive comprises a rebate.

31. The method of claim 1, wherein the identification code is at least one of a bar code, a numeric code, a digital code, a visual code, and a magnetic code.

32. The method of claim 1, wherein the transaction data describe an item purchased by the consumer.

33. The method of claim 1, wherein the transaction data describe when the consumer purchased an item.

34. The method of claim 1, wherein the transaction data describe where the consumer purchased an item.

35. The method of claim 1, wherein the transaction data describe a method of payment with which the consumer purchased an item.

36. An system for providing purchase transaction incentives using a financial product having an identification code that may be scanned at a point-of-sale terminal, the system comprising:
means for tracking a purchase transaction by a consumer based on identification data obtained from scanning of the identification code on the financial product;
means for receiving data relating to the transaction and receiving identification data relating to the identification code for storage in a transaction database; and
means for providing a purchase transaction incentive based on the stored data relating to the transaction and the stored identification data relating to the identification code, wherein the purchase transaction incentive provides an incentive to the consumer to make a purchase.

37. The system of claim 36, wherein the transaction data received from tracking the purchase transaction identify at least one of the items purchased, a merchant associated with the purchase, and the time the consumer made the purchase.

38. The system of claim 36, wherein the identification code identifies a particular consumer.

39. The system of claim 36, wherein the means for receiving the transaction data and the identification data further comprises:
means for associating the transaction data for a particular transaction with the identification data for that transaction; and
means for storing the transaction data and the identification data in the transaction database based on the association between the transaction data and the identification data.

40. The system of claim 36, wherein the means for providing the purchase transaction incentive further comprises:
means for selecting a subset of the stored transaction data based on predetermined market criteria describing a market population of consumers;
means for associating the selected subset of the stored transaction data with at least one particular consumer based on the stored identification data; and
means for providing the purchase transaction incentive to the at least one particular consumer.

41. The system of claim 40, wherein the predetermined market criteria correspond to selected transaction data stored in the transaction database.

42. The system of claim 40, wherein the means for providing the purchase transaction incentive further comprises:
means for identifying whether the consumers associated with the selected subset of the stored transaction data have purchased an item;
means for determining attributes of a first group of consumers in the market population who have purchased the item;
means for determining attributes of a second group of consumers in the market population who have not purchased the item; and
means for determining differences between the first group of consumers and the second group of consumers to identify attributes of consumers exhibiting a desired buying behavior.

43. The system of claim 42, wherein the attributes of the first and second group of consumers are included in the stored transaction data.

44. The system of claim 42, wherein the means for providing a purchase transaction incentive further comprises:
means for providing incentives to consumers in the second group of consumers.

45. The system of claim 40, wherein the means for providing the purchase transaction incentive further comprises:
means for selecting a marketing channel for providing the purchase transaction incentive to the market population of consumers; and
means for evaluating the success of the purchase transaction incentive, as provided through the marketing channel, based on the stored transaction data.

46. The system of claim 45, wherein the means for evaluating the success of the purchase transaction incentive further comprises:
means for associating stored transaction data with consumers who were provided the purchase transaction incentive based on the identification data;
means for analyzing the associated transaction data to determine whether the consumer purchased the item associated with the purchase transaction incentive; and
means for evaluating the success of the purchase transaction incentive based on the determined purchases of the item.

47. The system of claim 45, wherein the means for providing the purchase transaction incentive further comprises:
means for selecting a plurality of marketing channels for providing the purchase transaction incentive to the market population of consumers; and
means for ranking each marketing channel based on the success of the purchase transaction incentive as provided through that marketing channel.

48. The system of claim 47, wherein the means for providing the purchase transaction incentive further comprises:
means for providing the purchase transaction incentive using the highest ranked marketing channel.

49. The system of claim 40, wherein the means for providing the purchase transaction incentive further comprises: means for providing a plurality of purchase transaction incentives to the market population of consumers; and
means for ranking each purchase transaction incentive based on the success of the purchase transaction incentive.

50. The system of claim 49, wherein the means for ranking the purchase transaction incentive further comprises:
means for associating stored transaction data with consumers who were provided the purchase transaction incentive based on the identification data;
means for analyzing the associated transaction data to determine whether the consumer purchased the item associated with the purchase transaction incentive; and
means for ranking the purchase transaction incentive based on the determined purchases of the item.

51. The system of claim 49, wherein the means for providing the purchase transaction incentive further comprises:
means for providing to the consumer the highest ranked purchase transaction incentive.

52. The system of claim 36, wherein the transaction is at least one of a credit card transaction, a cash tender transaction, and a check tender transaction.

53. The system of claim 52, wherein the transaction is a credit card transaction using a credit card other than the credit card with the identification code.

54. The system of claim 36, wherein the purchase transaction incentive comprises a discount for an offered item.

55. The system of claim 36, wherein the means for providing the purchase transaction incentive further comprises:
means for associating the stored transaction data with at least one particular consumer based on the stored identification data; and
means for providing the incentive to the at least one particular consumer based on the transaction data associated with the particular consumer.

56. The system of claim 55, wherein the means for providing a purchase transaction incentive further comprises:
means for issuing to the at least one particular consumer reward points that may be used in a rewards point redemption program.

57. The system of claim 55, wherein the means for providing a purchase transaction incentive further comprises:
means for providing to the at least one particular consumer credit enhanced shopping opportunities.

58. The system of claim 55, wherein the means for providing a purchase transaction incentive further comprises:
means for providing to the consumer an advertisement to purchase an item.

59. The system of claim 55, further comprising:
means for using the identification code to facilitate a return of a purchased item to a merchant.

60. The system of clam 36, wherein the identification code identifies the consumer as belonging to a predefined group of consumers that may receive discounts when transacting with a participating retailer.

61. The system of claim 36, wherein the means for tracking a purchase transaction by a consumer further comprises:
means for determining whether the consumer is eligible for an instant purchase transaction incentive.

62. The system of claim 61, wherein providing a purchase transaction incentive further comprises:
means for providing an instant purchase transaction incentive at the point-of-sale terminal.

63. The system of claim 62, wherein the instant purchase transaction incentive comprises an instant coupon.

64. The system of claim 62, wherein the instant purchase transaction incentive comprises a percentage discount.

65. The system of claim 62, wherein the instant purchase transaction incentive comprises a rebate.

66. The system of claim 36, wherein the identification code is at least one of a bar code, a numeric code, a digital code, a visual code, and a magnetic code.

67. The system of claim 36, wherein the transaction data describe an item purchased by the consumer.

68. The system of claim 36, wherein the transaction data describe when the consumer purchased an item.

69. The system of claim 36, wherein the transaction data describe where the consumer purchased an item.

70. The system of claim 36, wherein the transaction data describe a method of payment with which the consumer purchased an item.

71. A computer for providing purchase transaction incentives using a financial product having an identification code that may be scanned at a point-of-sale terminal, the computer comprising:
a memory having programming instructions; and
a processor, responsive to the programming instructions, configured to:
track a purchase transaction by a consumer based on identification data obtained from scanning of the identification code on the financial product;
receive data relating to the transaction and receiving identification data relating to the identification code for storage in a transaction database; and
provide a purchase transaction incentive based on the stored data relating to the transaction and the stored identification data relating to the identification code, wherein the purchase transaction incentive provides an incentive to the consumer to make a purchase.

72. The computer of claim 71, wherein the transaction data received from tracking the purchase transaction identify at least one of the items purchased, a merchant associated with the purchase, and the time the consumer made the purchase.

73. The computer of claim 71, wherein the identification code identifies a particular consumer.

74. The computer of claim 71, wherein receiving the transaction data and the identification data further includes:
associating the transaction data for a particular transaction with the identification data for that transaction; and
storing the transaction data and the identification data in the transaction database based on the association between the transaction data and the identification data.

75. The computer of claim 71, wherein providing the purchase transaction incentive further includes:
selecting a subset of the stored transaction data based on predetermined market criteria describing a market population of consumers;
associating the selected subset of the stored transaction data with at least one particular consumer based on the stored identification data; and
providing the purchase transaction incentive to the at least one particular consumer.

76. The computer of claim 75, wherein the predetermined market criteria correspond to selected transaction data stored in the transaction database.

77. The computer of claim 75, wherein providing the purchase transaction incentive further includes:
identifying whether the consumers associated with the selected subset of the stored transaction data have purchased an item;
determining attributes of a first group of consumers in the market population who have purchased the item;
determining attributes of a second group of consumers in the market population who have not purchased the item; and
determining differences between the first group of consumers and the second group of consumers to identify attributes of consumers exhibiting a desired buying behavior.

78. The computer of claim 77, wherein the attributes of the first and second group of consumers are included in the stored transaction data.

79. The computer of claim 77, wherein providing a purchase transaction incentive further includes:
providing incentives to consumers in the second group of consumers.

80. The computer of claim 75, wherein providing the purchase transaction incentive further includes:
selecting a marketing channel for providing the purchase transaction incentive to the market population of consumers; and
evaluating the success of the purchase transaction incentive, as provided through the marketing channel, based on the stored transaction data.

81. The computer of claim 80, wherein evaluating the success of the purchase transaction incentive further includes:
associating stored transaction data with consumers who were provided the purchase transaction incentive based on the identification data;
analyzing the associated transaction data to determine whether the consumer purchased the item associated with the purchase transaction incentive; and
evaluating the success of the purchase transaction incentive based on the determined purchases of the item.

82. The computer of claim 80, wherein providing the purchase transaction incentive further includes:
selecting a plurality of marketing channels for providing the purchase transaction incentive to the market population of consumers; and
ranking each marketing channel based on the success of the purchase transaction incentive as provided through that marketing channel.

83. The computer of claim 82, wherein providing the purchase transaction incentive further includes:
providing the purchase transaction incentive using the highest ranked marketing channel.

84. The computer of claim 75, wherein providing the purchase transaction incentive further includes:
providing a plurality of purchase transaction incentives to the market population of consumers; and
ranking each purchase transaction incentive based on the success of the purchase transaction incentive.

85. The computer of claim 84, wherein ranking the purchase transaction incentive further includes:
associating stored transaction data with consumers who were provided the purchase transaction incentive based on the identification data;
analyzing the associated transaction data to determine whether the consumer purchased the item associated with the purchase transaction incentive; and
ranking the purchase transaction incentive based on the determined purchases of the item.

86. The computer of claim 84, wherein providing the purchase transaction incentive further includes:
providing to the consumer the highest ranked purchase transaction incentive.

87. The computer of claim 71, wherein the transaction is at least one of a credit card transaction, a cash tender transaction, and a check tender transaction.

88. The computer of claim 87, wherein the transaction is a credit card transaction using a credit card other than the credit card with the identification code.

89. The computer of claim 71, wherein the purchase transaction incentive comprises a discount for an offered item.

90. The computer of claim 71, wherein providing the purchase transaction incentive further includes:
associating the stored transaction data with at least one particular consumer based on the stored identification data; and
providing the incentive to the at least one particular consumer based on the transaction data associated with the particular consumer.

91. The computer of claim 90, wherein providing a purchase transaction incentive further includes:
issuing to the at least one particular consumer reward points that may be used in rewards point redemption program.

92. The computer of claim 90, wherein providing a purchase transaction incentive further includes:
providing to the at least one particular consumer credit enhanced shopping opportunities.

93. The computer of claim 90, wherein providing a purchase transaction incentive further includes:
means for providing to the consumer an advertisement to purchase an item.

94. The computer of claim 90, wherein the processor is further configured to:
use the identification code to facilitate a return of a purchased item to a i merchant.

95. The computer of clam 71, wherein the identification code identifies the consumer as belonging to a predefined group of consumers that may receive discounts when transacting with a participating retailer.

96. The computer of claim 71, wherein tracking a purchase transaction by a consumer further includes:
determining whether the consumer is eligible for an instant purchase transaction incentive.

97. The computer of claim 96, wherein providing a purchase transaction incentive further includes:
providing an instant purchase transaction incentive at the point-of-sale terminal.

98. The computer of claim 97, wherein the instant purchase transaction incentive comprises an instant coupon.

99. The computer of claim 97, wherein the instant purchase transaction incentive comprises a percentage discount.

100. The computer of claim 97, wherein the instant purchase transaction incentive comprises a rebate.

101. The computer of claim 71, wherein the identification code is at least one of a bar code, a numeric code, a digital code, a visual code, and a magnetic code.

102. The computer of claim 71, wherein the transaction data describe an item purchased by the consumer.

103. The computer of claim 71, wherein the transaction data describe when the consumer purchased an item.

104. The computer of claim 71, wherein the transaction data describe where the consumer purchased an item.

105. The computer of claim 71, wherein the transaction data describe a method of payment with which the consumer purchased an item.
